(19) United States
(12) Patent Application Publication
(10) Pub. No.: US 2026/0238888 A1
(43) Pub. Date: Aug. 13, 2026

(54) IMAGE PROCESSING DEVICE AND IMAGE PROCESSING METHOD

(71) Applicant: Sony Semiconductor Solutions Corporation, Kanagawa (JP)

(72) Inventors: Kentaro OKAMURA, Kanagawa (JP); Hirotaka SHINOZAKI, Kanagawa (JP)

(73) Assignee: Sony Semiconductor Solutions Corporation, Kanagawa (JP)

(21) Appl. No.: 19/155,967

(22) PCT Filed: Jan. 30, 2024
(86) PCT No.: PCT/JP2024/002739

§ 371 Date: Aug. 13, 2025

(30) Foreign Application Priority Data
Feb. 22, 2023 (JP) 2023-026636

(51) Int. Cl. H04N 23/85; G06T 3/4038; G06T 11/10; H04N 23/86

(52) U.S. Cl. CPC H04N 23/85; G06T 3/4038; G06T 11/10; H04N 23/86

(57) ABSTRACT

An image processing device according to an embodiment includes a remosaic processing unit and an image processing unit. The remosaic processing unit converts an array of pixels of three primary colors in an input image including pixels of red, green, and blue, which are the three primary colors of light and pixels of colors other than the three primary colors into a Bayer array, and generates a first three-primary color image including color information of the three primary colors and not including color information other than the three primary colors. The image processing unit generates a second three-primary color image including the color information of the three primary colors and the color information other than the three primary colors from the input image.

### FIELD

The present disclosure relates to an image processing device and an image processing method.

### BACKGROUND

A digital camera includes an image sensor. The image sensor includes a plurality of imaging elements corresponding to pixels of a captured image. The imaging elements are provided with, for example, color filters that selectively transmits beams of specific wavelength light such as red, green, and blue, respectively, which are three primary colors of light.

The image sensor photoelectrically converts beams of the light transmitted through the color filters by the respective imaging elements to generate three-primary color image, and outputs the three-primary color image to a camera system in a subsequent stage. The camera system executes color information complement processing, correction processing, and the like on the three-primary color image input from the image sensor, and outputs the processed three-primary color image to a display device, a storage device, or the like.

As an array of the color filters, a Bayer array in which green and blue color filters are alternately arranged in a row direction of pixels and green and red color filters are alternately arranged in a column direction of pixels has been the mainstream so far.

In recent years, an image sensor in which color filters are arranged so as to form an array different from the Bayer array has been developed for the purpose of achieve multi-functional and highly functional digital cameras. Examples of the array different from the Bayer array include quad Bayer coding (QBC).

In QBC, a pixel block of four adjacent pixels provided with a green color filter and a pixel block of four adjacent pixels provided with a blue color filter are alternately arranged in a row direction. In addition, in QBC, a pixel block of four adjacent pixels provided with a green color filter and a pixel block of four adjacent pixels provided with a red color filter are alternately arranged in the row direction.

As a result, the image sensor can suppress degradation of the resolution of an image, for example, at night or in the case of low illuminance. However, a general camera system in the subsequent stage assumes an input image in the Bayer array, and thus, cannot process an image in an array different from the Bayer array. Then, it takes a lot of time and cost to develop a camera system capable of processing an image of an array different from the Bayer array.

The image sensor can further increase the resolution of the image by converting pixels of the image captured by the QBC into the Bayer array in the daytime or in the case of high illuminance. Processing of converting an array different from the Bayer array into the Bayer array is called remosaic processing (see, for example, Patent Literature 1).

In addition, in a case where colors that can be received by the image sensor are three primary colors of red, green, and blue light, it is difficult to faithfully reproduce natural colors since spectral characteristics are different from those of naked eyes. Therefore, if the image sensor is provided with a color filter capable of receiving beams of light of colors other than the three primary colors in addition to the three primary colors of light, the reproducibility of natural colors can be improved.

### CITATION LIST

### Patent Literature

Patent Literature 1: JP 2013-66146 A

### SUMMARY

### Technical Problem

However, the general camera system cannot process an image including pixels of three primary colors and pixels of colors other than the three primary colors which are not in the Bayer array. Therefore, the image sensor needs to perform remosaic processing on the image including pixels of the three primary colors and pixels of colors other than the three primary colors, and output the resultant image to the camera system. However, when the remosaic processing is executed on the image including pixels of three primary colors and pixels of colors other than the three primary colors, color information other than the three primary colors is lost, and color reproducibility is deteriorated.

Therefore, the present disclosure proposes an image processing device and an image processing method capable of improving color reproducibility while executing remosaic processing.

### Solution to Problem

An image processing device according to an embodiment includes a remosaic processing unit and an image processing unit. The remosaic processing unit converts an array of pixels of three primary colors in an input image including pixels of red, green, and blue, which are the three primary colors of light and pixels of colors other than the three primary colors into a Bayer array, and generates a first three-primary color image including color information of the three primary colors and not including color information other than the three primary colors. The image processing unit generates a second three-primary color image including the color information of the three primary colors and the color information other than the three primary colors from the input image.

### BRIEF DESCRIPTION OF DRAWINGS

FIG. 1 is a schematic configuration diagram of an image processing device according to an embodiment.

FIG. 2 is a functional block diagram illustrating a configuration example of an image processing device according to the embodiment.

FIG. 3 is an explanatory view of reduced demosaic processing according to the embodiment.

FIG. 4 is a view illustrating an example of a 2D-LUT according to the embodiment.

FIG. 5 is a schematic configuration diagram of an image processing device according to a first modification of the embodiment.

FIG. 6 is a functional block diagram illustrating a configuration example of the image processing device according to the first modification of the embodiment.

FIG. 7 is a functional block diagram illustrating a configuration example of an image processing device according to a second modification of the embodiment.

FIG. 8 is an explanatory view of a modification of an input image according to the embodiment.

### DESCRIPTION OF EMBODIMENTS

Hereinafter, embodiments of the present disclosure will be described in detail with reference to the drawings. Note that the same portions are denoted by the same reference signs in each of the following embodiments, and a repetitive description thereof will be omitted.

### [1. Overview Configuration of Image Processing Device According to Embodiment]

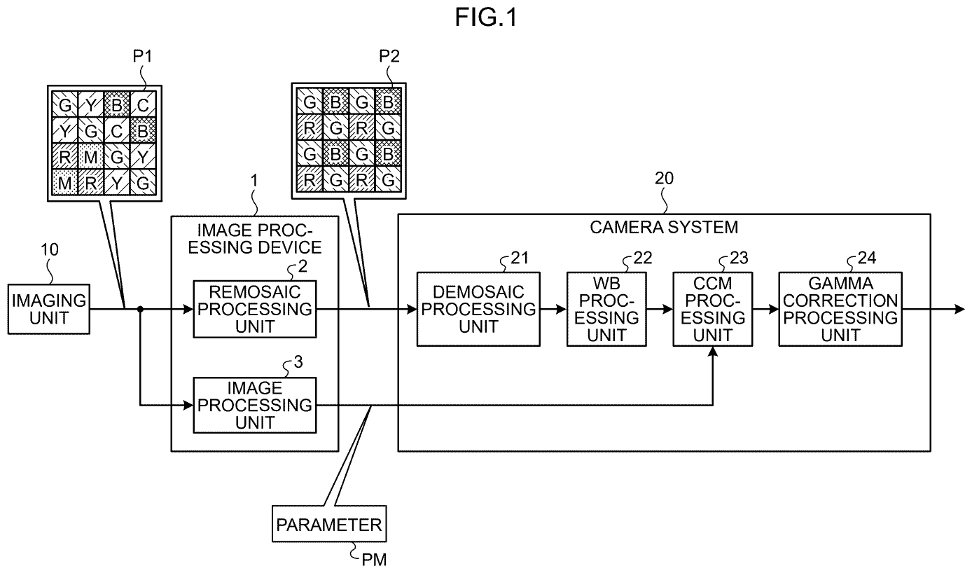

First, an overview configuration of an image processing device according to an embodiment will be described with reference to FIG. 1. FIG. 1 is a schematic configuration diagram of an image processing device 1 according to the embodiment. As illustrated in FIG. 1, the image processing device 1 is connected between an imaging unit 10 and a camera system 20. The imaging unit 10 includes a plurality of imaging elements corresponding to each of pixels of a captured image.

The plurality of imaging elements are arranged on a matrix, and are provided with color filters each selectively transmitting specific wavelength light. An imaging element of a general imaging unit is provided with a color filter that selectively transmits light of any one color of three primary colors of light, red, green, and blue.

However, in the camera system 20 in the subsequent stage, it is difficult to faithfully reproduce natural colors only with the three types of colors of red, green, and blue of light that can be received by the imaging unit 10. Therefore, the imaging element included in the imaging unit 10 according to the embodiment is provided with a color filter that selectively transmits light of any one color of three primary colors of light, cyan, magenta, and yellow.

That is, each of the imaging elements is provided with the color filter that selectively transmits light of any one color of red, green, blue, cyan, magenta, and yellow. Therefore, an array of the color filters in the imaging unit 10 is different from a Bayer array.

In the following description, red is described as R, green is described as G, blue is described as B, cyan is described as C, magenta is described as M, and yellow is described as Y.

Each of the imaging elements photoelectrically converts light incident through a lens and each of the color filters into a signal charge corresponding to the amount of received light, generates a captured image (hereinafter, described as an “input image P1”) including color information of six colors of R, G, B, C, Y, and M, and inputs the generated image to the image processing device 1.

In the present embodiment, the array of the color filters included in the imaging unit 10 is different from the Bayer array as described above. Therefore, an array of colors of pixels in the input image P1 is also different from the Bayer array.

On the other hand, in a case where it is assumed that an array of colors of pixels in an image to be processed is the Bayer array, the camera system 20 connected in the subsequent stage cannot process the input image P1 having an array different from the Bayer array.

Therefore, the image processing device 1 includes a remosaic processing unit 2. The remosaic processing unit 2 converts an array of R, G, and B pixels in the input image P1 including pixels of R, G, B, C, M, and Y into the Bayer array, generates a first three-primary color image P2 including color information of R, G, and B and not including color information of C, M, and Y, and outputs the generated image to the camera system 20.

Thus, the camera system 20 can process the first three-primary color image P2 input from the image processing device 1. The camera system 20 includes a demosaic processing unit 21, a white balance (hereinafter, described as “WB”) processing unit 22, and a color conversion matrix (hereinafter, referred to as “CCM”) processing unit 23 and a gamma correction processing unit 24.

The demosaic processing unit 21 complements the color information of each of the pixels arranged in the Bayer array in the first three-primary color image P2 on the basis of color information of adjacent pixels, and outputs the resultant image to the WB processing unit 22. The WB processing unit 22 performs processing of adjusting a reference of white in the first three-primary color image P2 such that white in the first three-primary color image P2 complemented with the color information input from the demosaic processing unit 21 becomes white regardless of a color temperature of a light source, and outputs the resultant image to the CCM processing unit 23. A specific example of WB processing will be described later.

The CCM processing unit 23 convolves a color conversion matrix set in advance with the color information of each of the pixels in the first three-primary color image P2 subjected to the WB processing to convert a color tone of the first three-primary color image P2 into a color tone desired by a user, and outputs the resultant image to the gamma correction processing unit 24. A specific example of CCM processing will be described later.

The gamma correction processing unit 24 corrects the color information of the first three-primary color image P2 to be color information corresponding to a gamma value unique to a display device such that colors of the first three-primary color image P2 subjected to the CCM processing are correctly displayed by the display device. The gamma correction processing unit 24 outputs the first three-primary color image P2 after the gamma correction to, for example, the display device or a storage device.

As described above, the camera system 20 can process the first three-primary color image P2, but since the first three-primary color image includes only the color information of R, G, and B and does not include color information of C, M, and Y, there is room for improvement in reproducibility of natural colors.

Therefore, in addition to the remosaic processing unit 2, the image processing device 1 according to the embodiment includes an image processing unit 3 that generates a second three-primary color image including color information other than R, G, and B from the input image P1. For example, the image processing unit 3 generates the second three-primary color image including color information of R, G, B, C, M, and Y from the input image P1.

Then, for example, the image processing unit 3 generates information necessary for reflecting the color information of C, M, and Y to the first three-primary color image P2 from the second three-primary color image in the camera system 20 in the subsequent stage, and outputs the generated information to the camera system 20.

For example, the image processing unit 3 calculates a coefficient (hereinafter, described as a “parameter PM”) of a color conversion matrix to be multiplied by the color information of R, G, and B in order to reflect the color information of C, M, and Y in the CCM processing unit 23 of the camera system 20, and outputs the coefficient to the CCM processing unit 23.

As a result, the image processing device 1 can reflect, for example, the color information of C, M, and Y to the first three-primary color image P2 in the camera system 20 in the subsequent stage. Therefore, the image processing device 1 can improve the reproducibility of natural colors in the input image P1 while executing remosaic processing even in the camera system 20 that can process only an image of the Bayer array.

### [2. Configuration Example of Image Processing Device]

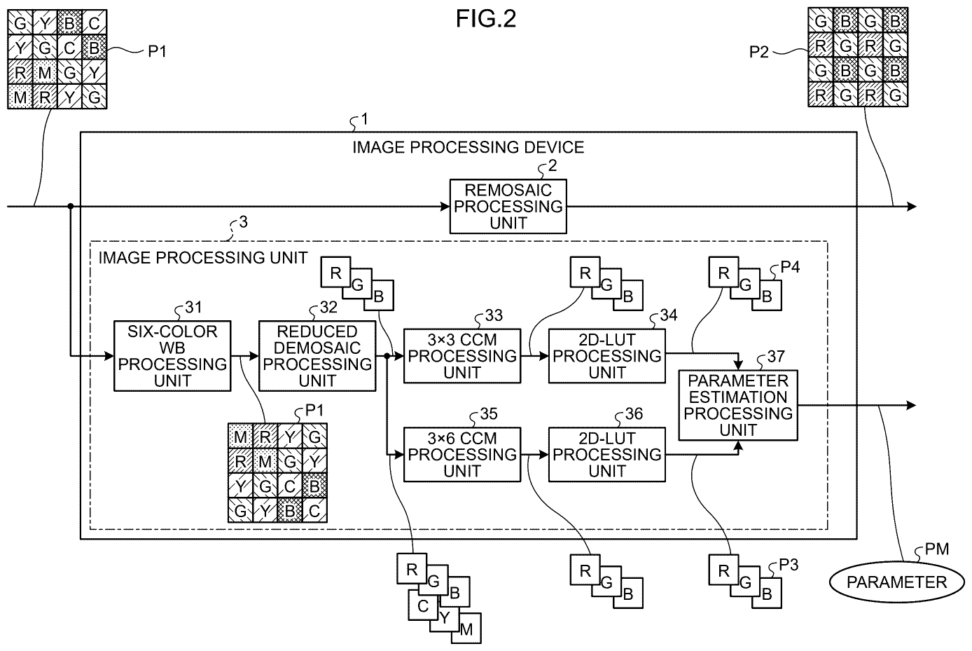

Next, a configuration example of the image processing device 1 according to the embodiment will be described with reference to FIG. 2. FIG. 2 is a functional block diagram illustrating the configuration example of the image processing device 1 according to the embodiment.

As illustrated in FIG. 2, the image processing device 1 includes the remosaic processing unit 2 and the image processing unit 3. The image processing unit 3 includes a six-color WB processing unit 31, a reduced demosaic processing unit 32, a 3×3 CCM processing unit 33, a 2D-LUT processing unit 34, a 3×6 CCM processing unit 35, a 2D-LUT processing unit 36, and a parameter estimation processing unit 37.

Some or all of the remosaic processing unit 2, the six-color WB processing unit 31, the reduced demosaic processing unit 32, the 3×3 CCM processing unit 33, the 2D-LUT processing unit 34, the 3×6 CCM processing unit 35, the 2D-LUT processing unit 36, and the parameter estimation processing unit 37 are configured by hardware such as an application specific integrated circuit (ASIC) or a field programmable gate array (FPGA).

Note that the remosaic processing unit 2, the six-color WB processing unit 31, the reduced demosaic processing unit 32, the 3×3 CCM processing unit 33, the 2D-LUT processing unit 34, the 3×6 CCM processing unit 35, the 2D-LUT processing unit 36, and the parameter estimation processing unit 37 may be configured by software.

In this case, the image processing device 1 includes a microcomputer including a central processing unit (CPU), a read only memory (ROM), a random access memory (RAM), and the like, and various circuits. The CPU executes a program stored in the ROM using the RAM as a work area to function as the remosaic processing unit 2, the six-color WB processing unit 31, the reduced demosaic processing unit 32, the 3×3 CCM processing unit 33, the 2D-LUT processing unit 34, the 3×6 CCM processing unit 35, the 2D-LUT processing unit 36, and the parameter estimation processing unit 37.

The remosaic processing unit 2 converts an array of pixels of the input image P1 having an array different from the Bayer array into the Bayer array, generates the first three-primary color image P2 including color information of R, G, and B and not including color information of C, M, and Y, and outputs the first three-primary color image P2 to the camera system 20.

The six-color WB processing unit 31 performs processing of adjusting a reference of white in the first three-primary color image P2 such that white in the input image P1 becomes white regardless of a color temperature of a light source. Specifically, the six-color WB processing unit 31 multiplies a gain (wbr) using the following Formula (1) such that pixel values of the color information of R, G, B, C, M, and Y become the same pixel value in a white region of the input image P1.

$$R\_out = R\_out * wb\_r \qquad ( 1 )$$

$$G\_out = G\_out * wb\_r$$

$$B\_out = B\_out * wb\_r$$

$$C\_out = C\_out * wb\_r$$

$$M\_out = M\_out * wb\_r$$

$$Y\_out = Y\_out * wb\_r$$

The input image P1 after the six-color WB processing is output to the reduced demosaic processing unit 32. Note that the WB processing unit 22 of the camera system 20 performs WB processing on the first three-primary color image P2 using the expression of R, G, and B in Formula (1).

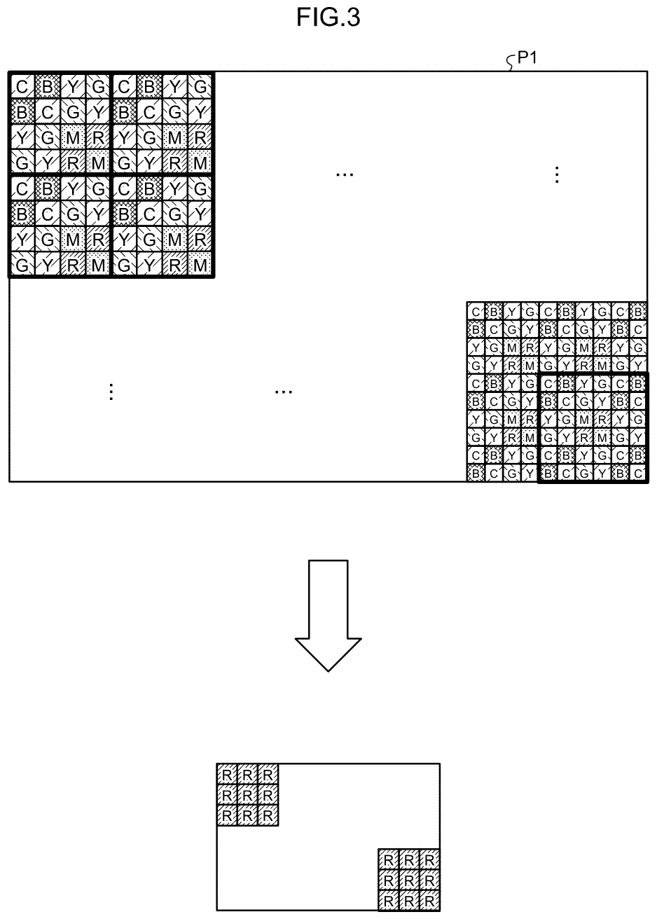

As illustrated in FIG. 3, the reduced demosaic processing unit 32 designates blocks of a predetermined size indicated by thick-line frames in the input image P1 after the six-color WB processing. Then, the reduced demosaic processing unit 32 averages pixel values of each color (R in the example illustrated in FIG. 3) in each of the blocks to be aggregated into one pixel.

For G, B, C, M, and Y, the reduced demosaic processing unit 32 similarly averages pixel values in each block to be aggregated into one pixel, thereby generating a reduced image including color information of six faces (six colors), and outputs the reduced image to the 3×6 CCM processing unit 35.

In addition, for R, G, and B, the reduced demosaic processing unit 32 averages pixel values in each block to be aggregated into one pixel, thereby generating a reduced image including color information of three faces (three colors), and outputs the reduced image to the 3×3 CCM processing unit 33.

The reduced demosaic processing unit 32 can generate a reduced image having a smaller number of pixels with respect to the input image P1 by increasing the size of the designated block. As a result, the image processing unit 3 can reduce the amount of memory used in image processing in the subsequent stage.

The 3×3 CCM processing unit 33 performs 3×3 CCM processing of convolving a 3×3 matrix of Formula (2) with values of R, G, and B of pixels in the reduced image, which includes color information of R, G, and B but does not include color information of C, M, and Y, to convert the values of R, G, and B into values close to true values of R, G, and B.

$$[ \begin{matrix}{R}_{xy}^{′} \\ {G}_{xy}^{′} \\ {B}_{xy}^{′}\end{matrix} ] = [ \begin{matrix}{a}_{00} & {a}_{01} & {a}_{02} \\ {a}_{10} & {a}_{11} & {a}_{12} \\ {a}_{20} & {a}_{21} & {a}_{22}\end{matrix} ] [ \begin{matrix}{R}_{xy} \\ {G}_{xy} \\ {B}_{xy}\end{matrix} ] \qquad ( 2 )$$

The 3×3 CCM processing unit 33 outputs the reduced image after the 3×3 CCM processing to the 2D-LUT processing unit 34. The CCM processing unit 23 of the camera system 20 performs 3×3 CCM processing similar to that of the 3×3 CCM processing unit 33.

The 3×6 CCM processing unit 35 performs 3×6 CCM processing of convolving a 3×6 matrix of Formula (3) with values of R, G, B, C, M, and Y of pixels in the reduced image including color information of R, G, B, C, M, and Y to convert the values of R, G, B, C, M, and Y into values close to true values of R, G, and B.

$$[ \begin{matrix}{R}_{xy}^{′} \\ {G}_{xy}^{′} \\ {B}_{xy}^{′}\end{matrix} ] = [ \begin{matrix}{a}_{00} & {a}_{01} & {a}_{02} \\ {a}_{10} & {a}_{11} & {a}_{12} \\ {a}_{20} & {a}_{21} & {a}_{22} \\ {a}_{30} & {a}_{31} & {a}_{32} \\ {a}_{40} & {a}_{41} & {a}_{43} \\ {a}_{50} & {a}_{51} & {a}_{53}\end{matrix} ] [ \begin{matrix}{R}_{xy} \\ {G}_{xy} \\ {B}_{xy} \\ {C}_{xy} \\ {M}_{xy} \\ {Y}_{xy}\end{matrix} ] \qquad ( 3 )$$

The 3×6 CCM processing unit 35 outputs the reduced image after the 3×6 CCM processing to the 2D-LUT processing unit 36.

The 2D-LUT processing units 34 and 36 convert the pixel values of R, G, and B of the reduced images input thereto into values of an HLS space including three components of hue (H), lightness (L), and saturation(S).

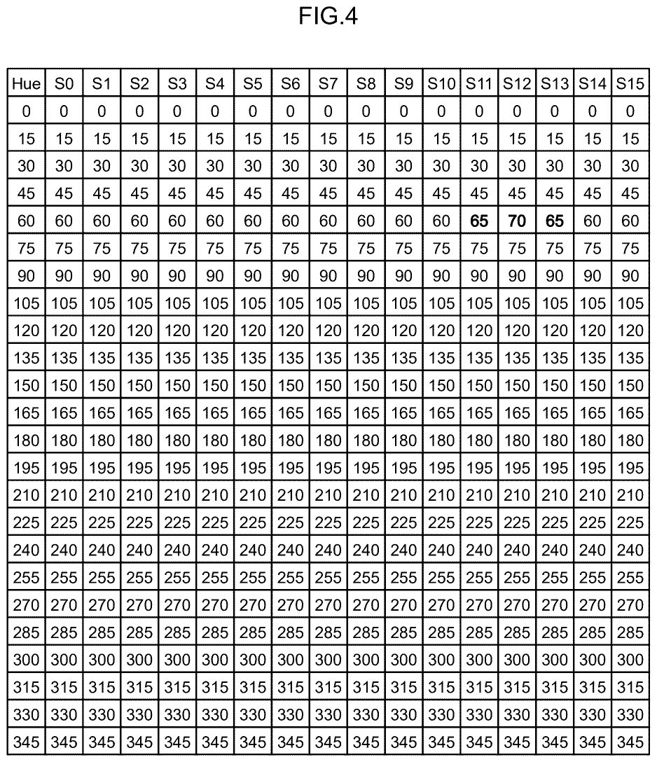

Then, the 2D-LUT processing units 34 and 36 finely adjust the values of hue (H) and saturation(S) using, for example, a look up table (LUT) illustrated in FIG. 4, thereby reproducing a color that cannot be expressed only by CCM. In a case where the LUT illustrated in FIG. 4 is used, for example, a value of hue (H) at saturation(S) of 11 to 13 is converted into 65, 70, and 65, respectively.

The 2D-LUT processing unit 34 outputs a three-primary color image including the color information of R, G, and B but not including the color information of C, M, and Y to the parameter estimation processing unit 37. The 2D-LUT processing unit 36 outputs a three-primary color image including the color information of R, G, B, C, M, and Y to the parameter estimation processing unit 37.

In this manner, the image processing unit 3 divides the input image P1 into a plurality of blocks, averages color information of a plurality of pixels of the same color for each color of R, G, B, C, M, and Y included in the block to be aggregated into one pixel, thereby generating a reduced image of the input image P1. Then, the image processing unit 3 generates a second three-primary color image P3 including color information of R, G, B, C, M, and Y from the reduced image.

In this manner, the image processing unit 3 divides the input image P1 into a plurality of blocks, averages color information of a plurality of pixels of the same color for each color of R, G, and B included in the block to be aggregated into one pixel, thereby generating a reduced image of the input image P1. Then, the image processing unit 3 generates a third three-primary color image P4 including color information of R, G, and B and not including color information of C, M, and Y from the reduced image.

The parameter estimation processing unit 37 compares the second three-primary color image P3 with the third three-primary color image P4, calculates the parameter PM of the color conversion matrix to be multiplied by the color information of the three primary colors in the first three-primary color image P2, and outputs the parameter PM to the CCM processing unit 23 of the camera system 20.

At this time, the parameter estimation processing unit 37 calculates the parameter PM that brings the hue and saturation of the first three-primary color image P2 closer to the hue and saturation of the second three-primary color image P3. Then, the parameter estimation processing unit 37 replaces and overwrites values of parameters a₀₀, a₀₁, a₀₂, a₁₀, a₁₁, a₁₂, a₂₀, a₂₁, and azz in Formula (2) used by the CCM processing unit 23 with the calculated parameter PM.

The camera system 20 can generate the three-primary color image reflecting the color information of C, M, and Y in the input image P1 by performing the CCM processing using Formula (2) to which the parameter PM is applied. As a result, the image processing device 1 can improve the color reproducibility by the camera system while executing the remosaic processing.

### [3. First Modification of Image Processing Device]

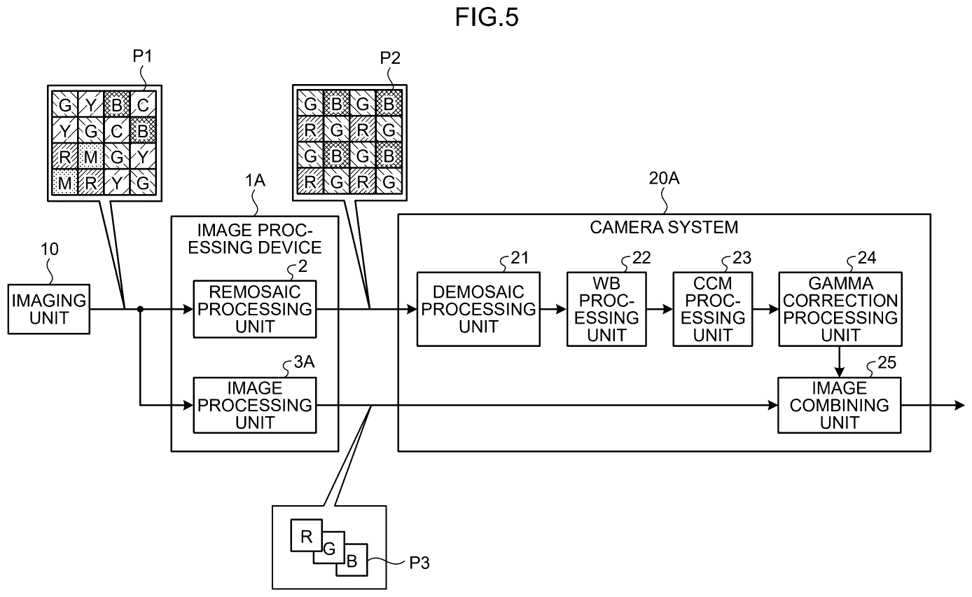

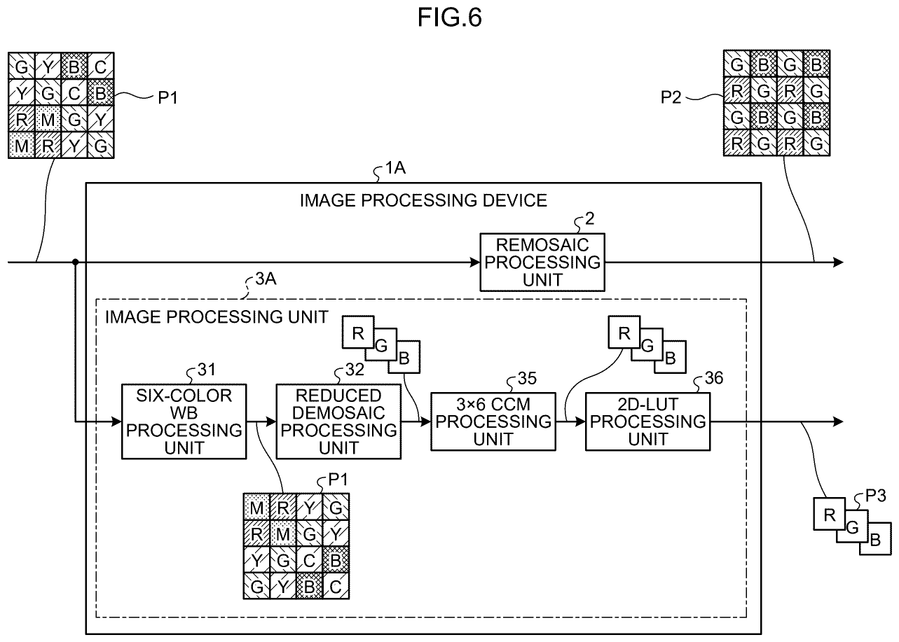

Next, an image processing device according to a first modification of the embodiment will be described with reference to FIGS. 5 and 6. FIG. 5 is a schematic configuration diagram of an image processing device 1A according to the first modification of the embodiment. FIG. 6 is a functional block diagram illustrating a configuration example of the image processing device 1A according to the first modification of the embodiment.

As illustrated in FIG. 5, the image processing device 1A includes the remosaic processing unit 2 and an image processing unit 3A. Similarly to the remosaic processing unit 2 illustrated in FIG. 1, the remosaic processing unit 2 converts the input image P1 including colors of R, G, B, C, M, and Y into the first three-primary color image P2 of the Bayer array and outputs the three-primary color image P2 to a camera system 20A.

The image processing unit 3A generates the second three-primary color image P3 including color information of R, G, B, C, M, and Y from the input image P1, instead of the parameter PM, and outputs the second three-primary color image P3 to the camera system 20A. Specifically, as illustrated in FIG. 6, the image processing unit 3A includes the six-color WB processing unit 31, the reduced demosaic processing unit 32, the 3×6 CCM processing unit 35, and the 2D-LUT processing unit 36.

The six-color WB processing unit 31, the reduced demosaic processing unit 32, the 3×6 CCM processing unit 35, and the 2D-LUT processing unit 36 illustrated in FIG. 6 perform the same processes as those of the six-color WB processing unit 31, the reduced demosaic processing unit 32, the 3×6 CCM processing unit 35, and the 2D-LUT processing unit 36 illustrated in FIG. 2, respectively.

On the other hand, as illustrated in FIG. 5, a camera system 20A according to the first modification includes an image combining unit 25 in addition to the components included in the camera system 20 illustrated in FIG. 2. The image combining unit 25 combines the first three-primary color image P2, which is input from the gamma correction processing unit 24 and includes the color information of R, G, and B and not include the color information of C, M, and Y, with the second three-primary color image P3 which is input from the image processing device 1A and includes the color information of R, G, B, C, M, and Y.

As a result, even if the 3×3 CCM processing unit 33, the 2D-LUT processing unit 34, and the parameter estimation processing unit 37 illustrated in FIG. 2 are not provided, the image processing device 1A can generate a three-primary color image reflecting the color information of C, M, and Y of the input image P1 using the camera system 20A.

### [4. Image Processing Device According to Second Modification]

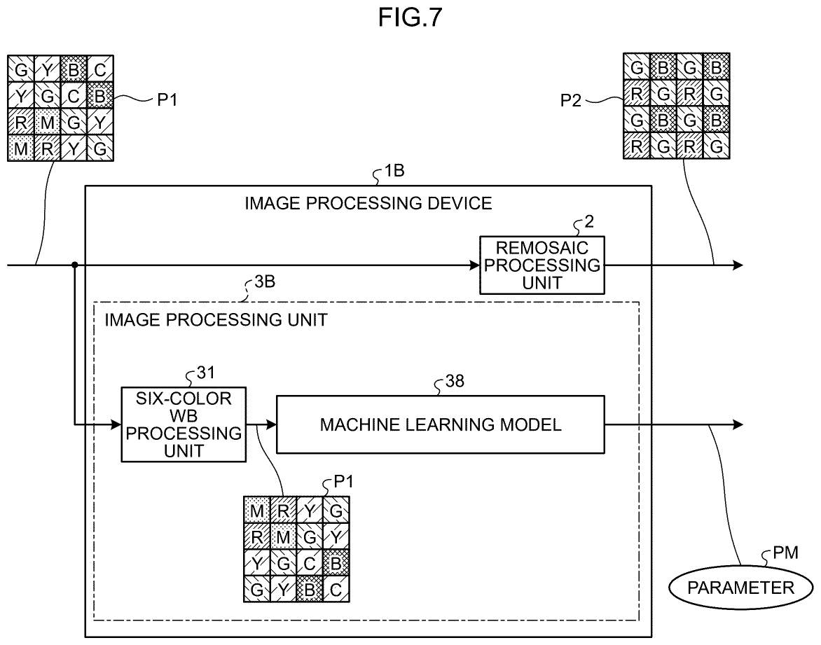

Next, an image processing device according to a second modification of the embodiment will be described with reference to FIG. 7. FIG. 7 is a functional block diagram illustrating a configuration example of an image processing device 1B according to the second modification of the embodiment.

As illustrated in FIG. 7, an image processing unit 3B of the image processing device 1B includes the six-color WB processing unit 31 and a machine learning model 38. The six-color WB processing unit 31 is the same as the six-color WB processing unit 31 illustrated in FIG. 2. The machine learning model 38 includes a deep neural network (DNN) or a convolutional neural network (CNN).

The machine learning model 38 is an arithmetic processing circuit obtained by machine learning so as to output the same parameter PM as the parameter PM output by the parameter estimation processing unit 37 illustrated in FIG. 2 when the input image P1 is input from the six-color WB processing unit 31.

That is, the machine learning model 38 performs machine learning so as to calculate the parameter PM that brings the hue and saturation of the first three-primary color image P2 from the input image P1 closer to the hue and saturation of the second three-primary color image P3.

For example, the machine learning model 38 is constructed by repeatedly performing machine learning of teacher data in which the input image P1 is used as an input and the parameter PM output from the image processing unit 3 illustrated in FIG. 2 when the input image P1 is input is the ground truth while changing a subject of the input image P1.

As a result, the image processing device 1B can calculate the parameter PM from the input image P1 and output the parameter PM to the camera system 20 in a subsequent stage similarly to the image processing unit 3 illustrated in FIG. 2 by the image processing unit 3B having a hardware configuration simpler than that of the image processing unit 3 illustrated in FIG. 2.

### [5. Modification of Input Image]

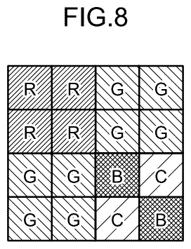

Next, a modification of the input image P1 will be described with reference to FIG. 8. FIG. 8 is an explanatory view of a modification of an input image according to the embodiment. In the examples illustrated in FIGS. 1 to 7, the input image P1 including the color information of R, G, B, C, M, and Y has been described as an example, but the input image according to the embodiment is not limited to the image including the color information of R, G, B, C, M, and Y.

For example, as illustrated in FIG. 8, the input image may be an image including color information of R, G, B, and C but not including color information of M and Y. In addition, the input image may be an image including color information of R, G, and B and color information of at least any one color out of the color information of C, M, and Y. In addition, the input image may be an image including color information of colors other than C, M, and Y. In this case, for example, the image processing device 1 executes CCM processing using a determinant corresponding to types of colors included in the input image, instead of Formula (3).

Note that the effects described in the present specification are merely examples and are not restrictive of the disclosure herein, and other effects also can be achieved.

### [6. Appendix]

Note that the present technology can also have the following configurations.
(1)
   An image processing device including:
   a remosaic processing unit that converts an array of pixels of red, green, and blue, which are three primary colors of light in an input image into a Bayer array, the input image including the pixels of the three primary colors, and pixels of colors other than the three primary colors, to generate a first three-primary color image that includes color information of the three primary colors and not include color information of the colors other than the three primary colors; and
   an image processing unit that generates a second three-primary color image, which includes color information of the three primary colors and color information other than the three primary colors, from the input image.
(2)
   The image processing device according to (1), wherein
   the remosaic processing unit
   outputs the first three-primary color image to a camera system in a subsequent stage, and
   the image processing unit
   generates, from the input image, a third three-primary color image that includes color information of the three primary colors and not include color information other than the three primary colors, and
   compares the second three-primary color image with the third three-primary color image to calculate a coefficient of a color conversion matrix to be multiplied by the color information of the three primary colors in the first three-primary color image, and outputs the coefficient to the camera system.
(3)
   The image processing device according to (2), wherein
   the image processing unit
   calculates the coefficient that brings hue and saturation of the first three-primary color image closer to hue and saturation of the second three-primary color image.
(4)
   The image processing device according to (1), wherein
   the remosaic processing unit
   outputs the first three-primary color image to a camera system in a subsequent stage, and
   the image processing unit
   outputs the second three-primary color image to the camera system.
(5)
   The image processing device according to any one of (1) to (4), wherein
   the image processing unit
   generates a reduced image of the input image by dividing the input image into a plurality of blocks and averaging color information of a plurality of pixels of a same color for each of the three primary colors and each of the colors other than the three primary colors included in each of the blocks to be aggregated into one pixel, and generates the second three-primary color image from the reduced image.
(6)
   The image processing device according to (2) or (3), wherein
   the image processing unit
   generates a reduced image of the input image by dividing the input image into a plurality of blocks and averaging color information of a plurality of pixels of a same color for each of the three primary colors included in each of the blocks to be aggregated into one pixel, and generates the third three-primary color image from the reduced image.
(7)
   The image processing device according to (1), wherein
   the image processing unit includes
   a machine learning model obtained by machine learning in such a manner as to calculate, from the input image, a coefficient that brings hue and saturation of the first three-primary color image closer to hue and saturation of the second three-primary color image as a coefficient of a color conversion matrix to be multiplied by the color information of the three primary colors in the first three-primary color image.
(8)
   An image processing method executed by an image processing device, the image processing method including:
   converting an array of pixels of red, green, and blue, which are three primary colors of light in an input image into a Bayer array, the input image including the pixels of the three primary colors, and pixels of colors other than the three primary colors, to generate a first three-primary color image that includes color information of the three primary colors and not include color information of the colors other than the three primary colors; and
   generating a second three-primary color image, which includes the color information of the three primary colors and the color information other than the three primary colors, from the input image.

### REFERENCE SIGNS LIST

1, 1A, 1B IMAGE PROCESSING DEVICE
10 IMAGING UNIT
2 REMOSAIC PROCESSING UNIT
3, 3A, 3B IMAGE PROCESSING UNIT
31 SIX-COLOR WB PROCESSING UNIT
32 REDUCED DEMOSAIC PROCESSING UNIT
33 3×3 CCM PROCESSING UNIT
34, 36 2D-LUT PROCESSING UNIT
35 3×6 CCM PROCESSING UNIT
37 PARAMETER ESTIMATION PROCESSING UNIT
38 MACHINE LEARNING MODEL
20, 20A CAMERA SYSTEM
21 DEMOSAIC PROCESSING UNIT
22 WB PROCESSING UNIT
23 CCM PROCESSING UNIT
24 GAMMA CORRECTION PROCESSING UNIT
25 IMAGE COMBINING UNIT
P1 INPUT IMAGE
P2 FIRST THREE-PRIMARY COLOR IMAGE
P3 SECOND THREE-PRIMARY COLOR IMAGE
P4 THIRD THREE-PRIMARY COLOR IMAGE
PM PARAMETER

1. An image processing device comprising:
a remosaic processing unit that converts an array of pixels of red, green, and blue, which are three primary colors of light in an input image into a Bayer array, the input image including the pixels of the three primary colors, and pixels of colors other than the three primary colors, to generate a first three-primary color image that includes color information of the three primary colors and not include color information of the colors other than the three primary colors; and
an image processing unit that generates a second three-primary color image, which includes color information of the three primary colors and color information other than the three primary colors, from the input image.

2. The image processing device according to claim 1, wherein
the remosaic processing unit
outputs the first three-primary color image to a camera system in a subsequent stage, and
the image processing unit
generates, from the input image, a third three-primary color image that includes color information of the three primary colors and not include color information other than the three primary colors, and
compares the second three-primary color image with the third three-primary color image to calculate a coefficient of a color conversion matrix to be multiplied by the color information of the three primary colors in the first three-primary color image, and outputs the coefficient to the camera system.

3. The image processing device according to claim 2, wherein
the image processing unit
calculates the coefficient that brings hue and saturation of the first three-primary color image closer to hue and saturation of the second three-primary color image.

4. The image processing device according to claim 1, wherein
the remosaic processing unit
outputs the first three-primary color image to a camera system in a subsequent stage, and
the image processing unit
outputs the second three-primary color image to the camera system.

5. The image processing device according to claim 1, wherein
the image processing unit
generates a reduced image of the input image by dividing the input image into a plurality of blocks and averaging color information of a plurality of pixels of a same color for each of the three primary colors and each of the colors other than the three primary colors included in each of the blocks to be aggregated into one pixel, and generates the second three-primary color image from the reduced image.

6. The image processing device according to claim 2, wherein
the image processing unit
generates a reduced image of the input image by dividing the input image into a plurality of blocks and averaging color information of a plurality of pixels of a same color for each of the three primary colors included in each of the blocks to be aggregated into one pixel, and generates the third three-primary color image from the reduced image.

7. The image processing device according to claim 1, wherein
the image processing unit includes
a machine learning model obtained by machine learning in such a manner as to calculate, from the input image, a coefficient that brings hue and saturation of the first three-primary color image closer to hue and saturation of the second three-primary color image as a coefficient of a color conversion matrix to be multiplied by the color information of the three primary colors in the first three-primary color image.

8. An image processing method executed by an image processing device, the image processing method comprising:
converting an array of pixels of red, green, and blue, which are three primary colors of light in an input image into a Bayer array, the input image including the pixels of the three primary colors, and pixels of colors other than the three primary colors, to generate a first three-primary color image that includes color information of the three primary colors and not include color information of the colors other than the three primary colors; and
generating a second three-primary color image, which includes the color information of the three primary colors and the color information other than the three primary colors, from the input image.
